(19) United States
(12) Patent Application Publication
(10) Pub. No.: US 2015/0176479 A1
(43) Pub. Date: Jun. 25, 2015

(54) OPEN-CLOSE CONTROL APPARATUS FOR OIL DRAIN HOLE

(71) Applicant: Ryu Hamaguchi, Toyota-shi (JP)

(72) Inventor: Ryu Hamaguchi, Toyota-shi (JP)

(73) Assignee: TOYOTA JIDOSHA KABUSHIKI KAISHA, Toyota-shi, Aichi-ken (JP)

(21) Appl. No.: 14/416,187

(22) PCT Filed: Oct. 16, 2013
(86) PCT No.: PCT/IB2013/002319

§ 371 Date: Jan. 21, 2015

(30) Foreign Application Priority Data
Oct. 23, 2012 (JP) 2012-233626

(51) Int. Cl. F02B 29/04

(52) U.S. Cl. CPC F02B 29/0468

(57) ABSTRACT

An open-close control apparatus for an oil drain hole of an engine that includes an intercooler and an oil drain hole formed in an intake passageway. The open-close control apparatus for an oil drain hole includes an open-close valve for opening and closing the oil drain hole and an ECU that performs such a control that the open-close valve opens during a stop of an engine. The ECU prohibits the control of opening and closing the open-close valve if an acquired value of the temperature of the open-close valve is less than or equal to a predetermined temperature.

### BACKGROUND OF THE INVENTION

1. Field of the Invention

The invention relates to an open-close control apparatus for opening and closing an oil drain hole for discharging oil accumulated in an intercooler.

2. Description of Related Art

Many engines are equipped, for the purpose of improving output, with a supercharger for forcing intake air into a combustion chamber and an intercooler for cooling the intake air pressurized by the supercharger to have high temperature and therefore become expanded. However, if an engine of this type is designed, for example, so that blowby gas is refluxed, oil having mixed in blowby gas is apt to accumulate in the intercooler. If the accelerator pedal is sharply depressed with a large amount of oil accumulated in the intercooler, there is possibility of the engine being damaged due to oil hammer.

In order to solve such a problem, for example, Japanese Patent Application Publication No. 2009-215915 (JP 2009-215915 A) proposes an oil accumulation prevention apparatus that opens an oil draining-through hole formed in the intercooler by actuating an open-close lid if it is detected by a sensor that oil is present in an oil receiver portion of the intercooler.

However, in the apparatus described in JP 2009-215915A, because whether to actuate the open-close lid is determined on the basis of only the presence or absence of oil in the oil receiver portion, a problem as follows may possibly occur. That is, in an intercooler, in addition to accumulation of oil as described above, accumulation of water occurs due to condensation while the vehicle is parked. Therefore, there is possibility that, at low temperatures, the water in the intercooler may congeal making the open-close lid (open-close valve) frozen. If, in that situation, an attempt is made to forcibly open or close the frozen open-close valve merely because of satisfaction of the condition that oil is present in the intercooler, there is possibility of damaging ₜhₑ open-close valve, a valve actuator, etc.

### SUMMARY OF THE INVENTION

The invention provides a technology that is for use in an open-close control apparatus for opening and closing an oil drain hole provided for use for discharging oil accumulated in an intercooler, and that, restrains an open-close valve or the like from being damaged.

In the invention, when there is high possibility that an open-close valve for opening and closing an oil drain hole is frozen, the opening/closing action of the open-close valve itself is avoided.

An open-close control apparatus according to the invention is provided for an engine that includes an intercooler for cooling intake air pressurized by a supercharger, and an oil drain hole for discharging oil accumulated in the intercooler, the oil drain hole being formed in or near the intercooler. The open-close control apparatus for the oil drain hole includes: an open-close valve for opening and closing the oil drain hole of the engine; and control means for controlling the open-close valve so that the open-close valve opens or closes, the control means acquiring temperature of the open-close valve, and prohibiting a control of opening and closing the open-close valve if the temperature acquired is less than or equal to a predetermined temperature.

According to the structure described above, the control means prohibits the control of opening and closing the open-close valve if the acquired temperature of the open-close valve is less than or equal to the predetermined temperature, that is, if there is high possibility that the open-close valve is frozen. This construction can avoid, for example, an event in which when the open-close valve is frozen in a closed state, the control is performed so as to forcibly open the open-close valve in order to discharge oil accumulated in the intercooler. Therefore, damage to the open-close valve, the valve actuator or the like can be restrained.

In the invention, the “predetermined temperature” may be, for example, 0° C., which is the freezing point of water.

The open-close control apparatus may further include temperature detection means provided near the open-close valve, and the control means may acquire the temperature of the open-close valve based on a result of detection provided by the temperature detection means.

According to the structure described above, the control means acquires the temperature of the open-close valve on the basis of the temperature detected by the temperature detection means provided near the open-close valve. Therefore, the temperature of the open-close valve can be acquired more accurately than, for example, in the case where the temperature of the open-close valve is acquired (estimated) from an existing temperature sensor, the supercharge pressure, etc. In consequence, it becomes possible to highly accurately determine whether the open-close valve is frozen, and therefore damage to the open-close valve or the like can be restrained.

As described above, according to the open-close control apparatus for an oil drain hole in accordance with the invention, damage to the open-close valve or the like can be restrained since the open-close control apparatus is constructed so as to prohibit the control of opening and closing the open-close valve if the acquired temperature of the open-close valve is less than or equal to a predetermined temperature.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a general construction diagram of an internal combustion engine in accordance with an embodiment of the invention;

FIG. 2 is a general construction diagram schematically illustrating an open-close apparatus; and

FIG. 3 is a flowchart showing an open-close control procedure for an oil drain hole.

### DETAILED DESCRIPTION OF EMBODIMENTS

Forms for carrying out the invention will be described hereinafter with reference to the drawings.

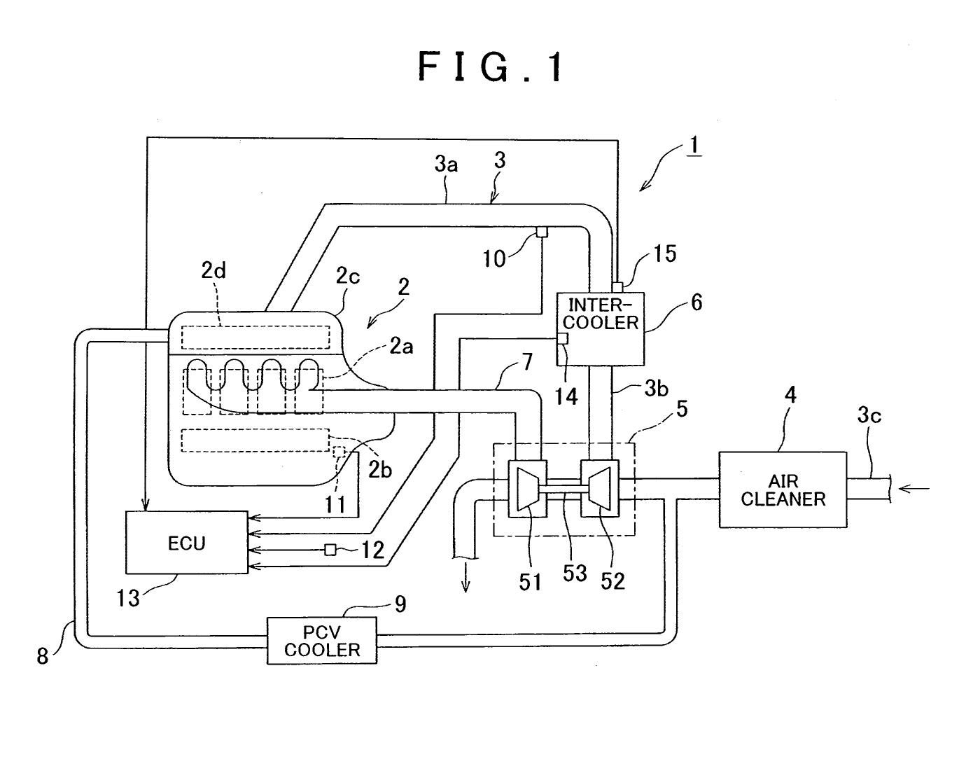

FIG. 1 shows a simplified illustration of an overall construction of an internal combustion engine in accordance with an embodiment of the invention.

In FIG. 1, an internal combustion engine (engine) 1 is mounted in a vehicle, and includes an engine body 2 and an ECU (electronic control unit) 13 that administers operation control of the engine 1. The engine 1 has an air cleaner 4, a turbocharger (supercharger) 5 and an air-cooled type intercooler 6 that are provided in that order from an upstream side on an intake passageway 3. Incidentally, in this engine 1, the intake passageway 3 is constructed of an intake passageway 3c provided on an upstream side of the air cleaner 4, an intake passageway 3b that connects the air cleaner 4 and the intercooler 6, and an intake passageway 3a provided on a downstream side of the intercooler 6.

The turbocharger 5 has a compressor wheel 52 that is provided in the intake passageway 3b, a turbine wheel 51 that is provided in an exhaust passageway 7, and a turbine shaft 53 that connects the turbine wheel 51 and the compressor wheel 52. Due to this construction, in this turbocharger 5, exhaust gas discharged from the combustion chamber 2a rotates the turbine wheel 51 and therefore rotates the compressor wheel 52, whereby external air introduced through the intake passageway 3c is compressed and then is forced into combustion chambers 2a of the engine body 2.

Incidentally, the intake passageway 3b connecting the turbocharger 5 and the air cleaner 4 is connected to a cylinder head cover 2c of the engine body 2 by a blowby gas passageway 8 for refluxing blowby gas in a ventilation case 2d back into an intake system. The blowby gas passageway 8 is provided with a PCV cooler 9 for cooling blowby gas. The PCV cooler 9 is an air-cooled type cooler similar to the intercooler 6, and is provided near the intercooler 6, within an engine compartment of a vehicle. In FIG. 1, the PCV cooler 9 is shown at a location apart from the intercooler 6 for the sake of convenience.

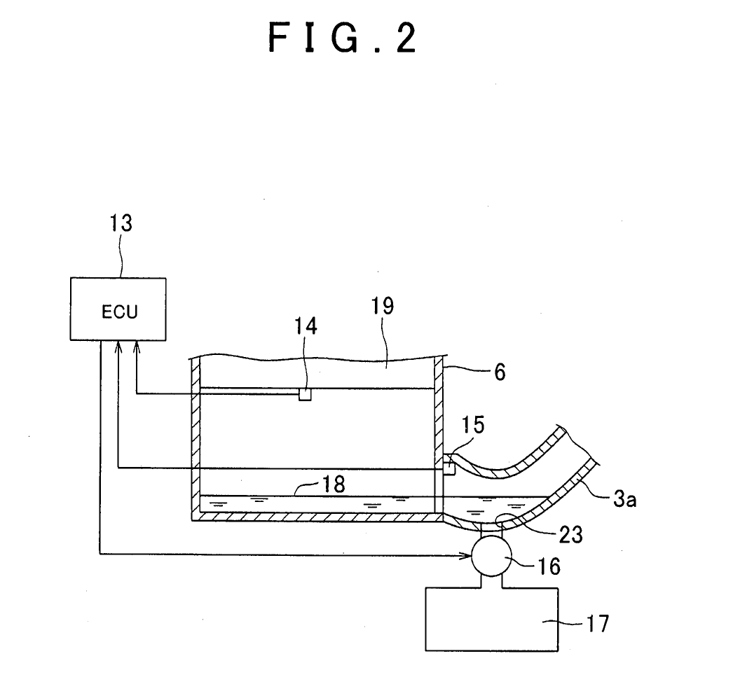

The intercooler 6 is provided in an intake passageway 3 which is on the downstream side of the compressor wheel 52. In this intercooler 6, an air-cooled heat exchanger 19 is provided in a substantially middle portion of the intercooler 6 in an up-down direction (see FIG. 2). The high-temperature intake air introduced from the intake passageway 3b into the intercooler 6 is cooled due to heat exchange in the heat exchanger 19 with external air. Incidentally, the heat exchanger 19 is not limited to an air-cooled heat exchanger but may also be a water-cooled heat exchanger.

Due to the structure described above, in this engine 1, as the turbine wheel 51 is rotated by exhaust gas, the compressor wheel 52 rotates, so that external air coming through the air cleaner 4 and blowby gas coming through the blowby gas passageway 8 (hereinafter, which will be collectively termed the intake' air as well) are compressed and the intake air raised in temperature due to compression and therefore expanded enters the intercooler 6. Thus, the intake air is cooled and reduced in volume by the intercooler 6 is supplied into the combustion chambers 2a of the engine body 2.

Furthermore; the engine 1 is provided with various sensors for detecting states of operation of the engine 1. Concretely, there are provided a supercharge pressure sensor 10 for detecting the intake air pressure (supercharge pressure) on the downstream side of the intercooler 6, a crank angle sensor 11 for detecting the engine rotation speed, and an accelerator sensor 12 for detecting the amount of accelerator depression.

Detection signals from the supercharge pressure sensor 10, the crank angle sensor 11 and the accelerator sensor 12 are sent to the ECU 13. The ECU 13 centrally executes various controls of the engine 1, and is equipped with a memory that stores control programs and necessary data for execution of the programs, and the like. Therefore, on the basis of the amount of accelerator depression found from the detection signal from the accelerator sensor 12, the engine rotation speed found from the detection signal from the crank angle sensor 11, etc., the ECU 13 calculates command values regarding the amount of fuel injection and the fuel injection timing. Then, on the basis of these command values, the ECU 13 controls the amount of fuel injection and the fuel injection timing so as to achieve good thermal efficiency, good exhaust emission, etc.

In this engine 1, when blowby gas is refluxed to the intake system as mentioned above, the blowby gas leaking from the combustion chambers 2a into a crank chamber 2b is introduced into the ventilation case 2d through a gas passageway (not shown) that is formed within the engine body 2. The ventilation case 2d is provided with a baffle plate (not shown). Oil mist contained in blowby gas deposits on the baffle plate, and is therefore separated from blowby gas, whereby the oil in blowby gas is restrained from flowing out into the intake system. However, it is difficult to completely remove oil from blowby gas. Therefore, in the engine 1 equipped with the intercooler 6, oil left unremoved is likely to accumulate in the intercooler 6. Then, the oil accumulated in the intercooler 6, at the time of sharp and great depression of the accelerator pedal, is immediately sucked into the engine body 2, giving rise to possibility of causing oil hammer or the like and damaging the engine body 2.

Therefore, in the engine 1 in this embodiment 1, an oil drain hole 23 for discharging oil accumulated in the intercooler 6 is formed near the intercooler 6, and an open-close control apparatus that opens and closes the oil drain hole 23 according to the state of the engine 1 or to the presence or absence of oil in the intercooler 6 is provided.

More specifically, as shown in FIG. 2, the intake passageway 3a is connected to a lower portion of the intercooler 6 in such a manner that a lower end portion of an internal passageway of a connecting end portion of the intake passageway 3a at which the intake passageway 3a is connected to the intercooler 6 is lower than an internal bottom surface of the intercooler 6. The oil drain hole 23 for discharging oil 18 accumulated in the intercooler 6 is formed at the lowest site in the internal passageway of the intake passageway 3a. Since the oil drain hole 23 is formed at the lowest site in a combination of the intercooler 6 and the intake passageway 3a connected to the intercooler 6 as described above, the oil 18 accumulated in the intercooler 6 is naturally discharged from the oil drain hole 23 if the oil drain hole 23 is open.

The oil drain hole 23 is provided with an open-close valve 16 that opens and closes on the basis of a command from the ECU 13. When the ECU 13 opens the open-close valve 16 by actuating a valve actuator (not shown), the oil 18 accumulated in the intercooler 6 is discharged into a drain tank 17 through the oil drain hole 23.

It is to be noted herein that when the ECU 13 performs a control such that the open-close valve 16 opens provided that the engine 1 is in a stopped state and that the oil 18 is present in the intercooler 6. That is, the ECU 13 opens the open-close valve 16 provided that there is no need to maintain a predetermined intake air pressure on the downstream side of the intercooler 6 and that the oil 18 needs to be discharged. Then, when the oil 18 has been discharged following the opening of the open-close valve 16, which corresponds to when the intercooler 6 does not contain any oil to be discharged, the ECU 13 closes the open-close valve 16. On the other hand, when the engine 1 is in operation or the oil 18 is not present in the intercooler 6, the ECU 13 does not open the open-close valve 16. Therefore, when the engine 1 is in operation, the predetermined intake air pressure on the downstream side of the intercooler 6 can be maintained and the unnecessary opening/closing of the open-close valve 16 can be restrained.

In order to realize the above-described control, this embodiment includes, in addition to the aforementioned various sensors 10, 11, 12, an infrared type sensor 14 for detecting the presence or absence of the oil 18 in the intercooler 6. The infrared type sensor 14 is provided within the intercooler 6. The infrared type sensor 14 is attached to a lower end portion of the air-cooled heat exchanger 19 which faces the internal bottom surface of the intercooler 6. The infrared type sensor 14 disposed in this manner is able to emit infrared light toward the internal bottom surface of the intercooler 6 and receive reflected light from the bottom surface. The infrared type sensor 14 detects the presence or absence of the oil 18 in the intercooler 6 by utilizing a characteristic of infrared light that when the oil 18 is present on the internal bottom surface of the intercooler 6, the reflected light therefrom is relatively weak, and that when the oil 18 is not present on the internal bottom surface of the intercooler 6, the reflected light therefrom is relatively strong.

The ECU 13 firstly determines whether the engine body 2 is in the stopped state, for example, on the basis of the detection signal form the crank angle sensor 11. If the engine body 2 is in the stopped state, the ECU 13 further determines the presence or absence of the oil 18 in the intercooler 6 on the basis of the detection signal from the infrared type sensor 14. If the oil is present in the intercooler 6, the ECU 13 opens the open-close valve 16 to discharge the oil accumulated in the intercooler 6.

In this manner, the open-close control apparatus discharges the oil 18 accumulated in the intercooler 6, when the state or timing is appropriate. However, besides the oil 18, other liquids, such as fuel, water, etc., can also accumulate in the intercooler 6 in manners as described below. That is, if the valve closure timing of the intake valves is retarded from a reference valve closure timing, there occurs blowback of intake air in which intake air once supplied into a cylinder is returned into the intake passageway, and hence the fuel injected from injectors is blown back into the intake passageway, and accumulates in the intercooler 6. Furthermore, due to condensation occurring while the vehicle is parked, water can accumulate in the intercooler 6. If liquids, such as fuel, water, etc., accumulate in the intercooler 6, it is conceivable that the liquids congeal at low temperatures, making the open-close valve 16 frozen. If an attempt is made to forcibly open the frozen open-close valve 16, there arises a risk of damaging the open-close valve 16 or the valve actuator.

Therefore, the open-close control apparatus in the embodiment is further equipped with an intake air temperature sensor (temperature detection means) 15 near the open-close valve 16. On the basis of a result of detection provided by the intake air temperature sensor 15, the ECU 13 acquires a value of the temperature of the open-close valve 16. If the acquired temperature is less than or equal to a predetermined temperature, the ECU 13 prohibits the control of opening and closing the open-close valve 16.

More specifically, in the open-close control apparatus of this embodiment, the intake air temperature sensor 15 for detecting the temperature of intake air is disposed in the vicinity of the open-close valve 16 (more precisely, in a connecting portion of the intake passageway 3a at which the intake passageway 3a is connected to the intercooler 6). Thus, since the intake air temperature sensor 15 is provided at a site that is likely to be struck by a main stream of intake air, the ECU 13 can appropriately acquire the temperature of the vicinity of the intercooler 6 from the temperature of intake air and can also acquire temperature T₁ of the open-close valve 16 provided in the vicinity of the intercooler 6. Incidentally, in order to more accurately detect the temperature of the open-close valve 16, the intake air temperature sensor 15 may be provided at a site where the temperature of the open-close valve 16 itself or its valve seat can be directly detected.

Then, if the acquired temperature T₁ is less than or equal to a predetermined temperature Tₒ (e.g., 0° C., which is the freezing point of water), the ECU 13 determines that the open-close valve 16 is frozen. In that case, the ECU 13 does not perform the control of opening and closing the open-close valve 16 (does not open the open-close valve 16), even when the engine 1 is in the stopped state and the oil 18 is present in the intercooler 6. This makes it possible to restrain damage from being caused on the open-close valve 16, the valve actuator, etc., by the forcible opening/closing of the frozen open-close valve 16.

On the other hand, if the acquired temperature T₁ exceeds the predetermined temperature T₀, the ECU 13 determines that the open-close valve 16 is not frozen, and performs the control of opening and closing the open-close valve 16 (opens the open-close valve 16) on condition that the engine 1 is in the stopped state and the oil 18 is present in the intercooler 6. This makes it possible to discharge the oil 18 accumulated in the intercooler 6 during an appropriate state or at appropriate timing, without damaging the open-close valve 16 or the valve actuator.

Due to the foregoing construction, the ECU 13, the open-close valve 16, the crank angle sensor 11, the infrared type sensor 14, the intake air temperature sensor 15, etc., function as the open-close control apparatus of the embodiment.

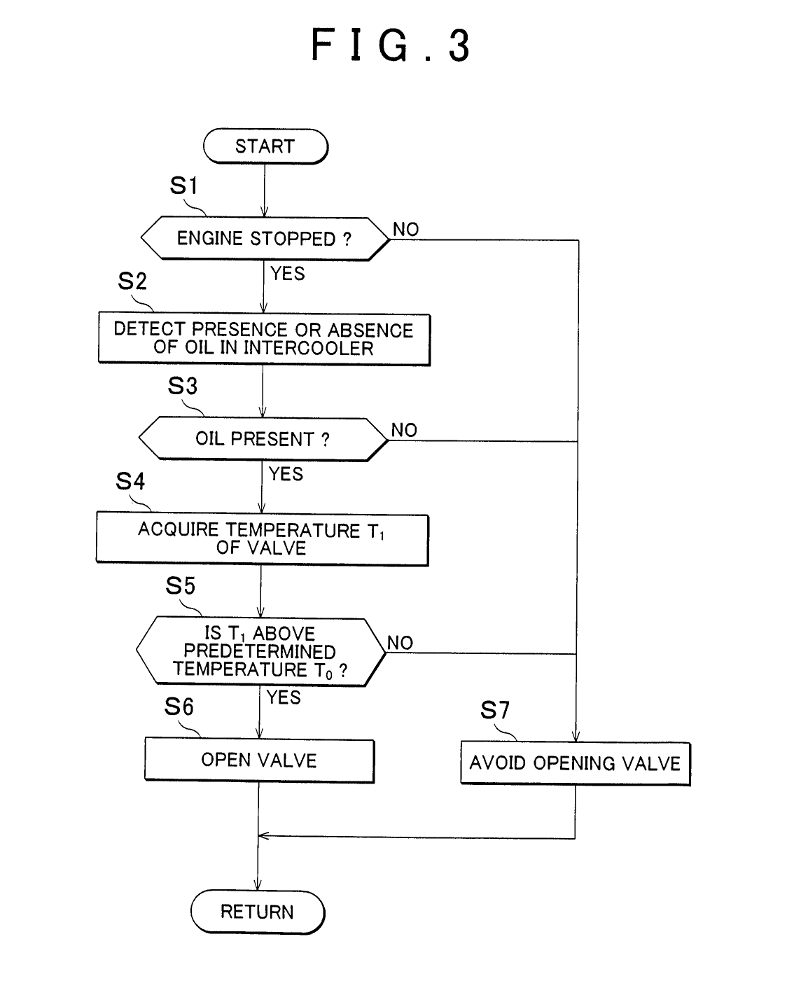

Next, the open-close control for the oil drain hole which is performed by the open-close control apparatus of the embodiment will be described with reference to a flowchart shown in FIG. 3.

Firstly, in step S1, the ECU 13 determines whether the engine body 2 is in the stopped state on the basis of the detection signal from the crank angle sensor 11 or the like. If the answer to the determination in step S1 is NO, that is, if the engine body 2 is in operation, the ECU 13 proceeds to step S7, in which the ECU 13 avoids opening the open-close valve 16, so that a predetermined intake air pressure during operation of the engine will be maintained, irrespective of whether the oil 18 is accumulated in the intercooler 6. After that, the process returns. On the other hand, if the answer to the determination in step S1 is YES, that is, if the engine body 2 is in the stopped state, the process proceeds to step S2.

In step S2, the ECU 13 detects the presence or absence of the oil 18 in the intercooler 6 by using the infrared type sensor 14. Subsequently, in step S3, the ECU 13 determines whether the oil 18 is present in the intercooler 6 on the basis of the detection signal from the infrared type sensor 14 obtained in step S2. If the answer to the determination in step S3 is NO, that is, if the oil 18 is not present in the intercooler 6, the ECU 13 proceeds to step S7, in which the ECU 13 avoids opening the open-close valve 16. After that, the process returns. On the other hand, if the answer to the determination in step S3 is YES, that is, if the oil 18 is present in the intercooler 6, the process proceeds to step S4.

Then, in step S4, the ECU 13 acquires the temperature T₁ of the open-close valve 16 on the basis of the detection signal from the intake air temperature sensor 15.

Subsequently, in step S5, the ECU 13 determines whether the temperature T₁ of the open-close valve 16 acquired in step S4 exceeds the predetermined temperature T₀. If the answer to the determination in step S5 is NO, that is, if the temperature T₁ of the open-close valve 16 is less than or equal to the predetermined temperature T₀, there is high possibility that the open-close valve 16 is frozen. Therefore, the process proceeds to step S7, in which the ECU 13 avoids opening the open-close valve 16. After that, the process returns. On the other hand, if the answer to the determination in step S5 is YES, that is, if the temperature T₁ of the vicinity of the open-close valve 16 exceeds the predetermined temperature T₀, the process proceeds to step S6.

Then, in step S6, the ECU 13 opens the open-close valve 16 to discharge the oil 18 accumulated in the intercooler 6. After that, the process returns.

### Other Embodiments

The invention is not limited to foregoing embodiment, but can be carried out in various forms without departing from the spirit or the main feature thereof.

Although in the foregoing embodiment, the oil drain hole 23 for discharging the oil 18 accumulated in the intercooler 6 is formed in the intake passageway 3a, this is not restrictive. For example, the oil drain hole 23 may also be formed in a bottom portion of the intercooler 6.

Furthermore, although in the embodiment, the temperature of the open-close valve 16 is acquired by using the intake air temperature sensor 15 provided in the vicinity of the intercooler 6, this is not restrictive. For example, the temperature of the open-close valve 16 may also be acquired (estimated) by using the supercharge pressure sensor 10 and a temperature sensor that is provided for the engine 1 in the related art.

Still further, although the embodiment uses, as a supercharger, the turbocharger (exhaust gas turbine supercharger) 5 that utilizes exhaust gas from the engine body 2, this is not restrictive. It is also permissible to use a supercharger (mechanically driven supercharger) in which the compressor is driven by power extracted from the crankshaft of the engine body 2 via a belt or the like.

Furthermore, although in the embodiment, the open-close valve 16 is opened when the engine 1 is in the stopped state and the oil 18 is present in the intercooler 6, this is not restrictive. For example, it is also permissible to adopt a construction in which the infrared type sensor 14 is omitted and the open-close valve 16 is opened when the engine is in the stopped state.

Thus, the foregoing embodiments are mere illustrations in all respects, and should not be restrictively interpreted. Furthermore, modifications and changes that belong to the scope of the claims or the equivalent scope are all within the scope of the invention.

As described above, the invention is able to restrain damage to the open-close valve or the valve actuator, and therefore is applicable to open-close control apparatuses for an oil drain hole for discharging oil accumulated in an intercooler.

1-3. (canceled)

4. An open-close control apparatus for an oil drain hole of an engine that includes an intercooler for cooling intake air pressurized by a supercharger and an intake passageway connected to a lower portion of the intercooler the intake passageway having the oil drain hole, the oil drain hole being provided at the lowest site in an internal passageway of the intake passageway, and the oil drain hole being configured to discharge oil accumulated in the intercooler, the open-close control apparatus, comprising:
an open-close valve configured to opening and closing the oil drain hole;
a temperature detector disposed in a vicinity of the open-close valve at the intake passageway; and
an electronic control unit configured to
(i) control the open-close valve such that the open-close valve opens or closes
(ii) acquire temperature of the open-close valve based on a result of detection provided by the temperature detector, and
(iii) prohibit a control of opening and closing the open-close valve when the temperature acquired is less than or equal to a predetermined temperature.

5. The open-close control apparatus for the oil drain hole according to claim 4, wherein
the electronic control unit is configured to prohibit the control of opening and closing the open-close valve when the temperature of the open-close valve is less than or equal to 0° C.
